(19) United States
(12) Patent Application Publication
(10) Pub. No.: US 2025/0246759 A1
(43) Pub. Date: Jul. 31, 2025

(54) HIGH-POWER ALL-SOLID-STATE BATTERY CELL WITH SULFIDE SOLID ELECTROLYTE AND SILICON ANODE ELECTRODE

(71) Applicant: GM GLOBAL TECHNOLOGY OPERATIONS LLC, Detroit, MI (US)

(72) Inventors: Zhe LI, Shanghai (CN); Qili SU, Shanghai (CN); Meiyuan WU, Shanghai (CN); Yong LU, Shanghai (CN); Haijing LIU, Shanghai (CN)

(21) Appl. No.: 18/667,479

(22) Filed: May 17, 2024

(30) Foreign Application Priority Data
Jan. 31, 2024 (CN) 2024101411921

(51) Int. Cl. H01M 50/46; H01M 4/02; H01M 4/131; H01M 4/36; H01M 4/485; H01M 4/525; H01M 10/056; H01M 50/414; H01M 50/431

(52) U.S. Cl. CPC H01M 50/46; H01M 4/131; H01M 4/366; H01M 4/485; H01M 4/525; H01M 10/056; H01M 50/414; H01M 50/431; H01M 2004/021; H01M 2300/008; H01M 2300/0082; H01M 2300/0091

(57) ABSTRACT

An all-solid-state battery cell includes A anode electrodes each including an anode active material layer arranged on an anode current collector. The anode current collector comprises a roughened outer surface, the anode active material layer comprises silicon, and the outer surface of the anode active material layer includes a plurality of convex spherical shapes. C cathode electrodes each including a cathode active material layer arranged on a cathode current collector. The cathode active material layer includes cathode active material and a sulfide solid electrolyte. The cathode active material is selected from a group consisting of LiNiₓMn_{y}Co_{1-x-y}O₂ (where 0.95>x≥0.33; and y≥0.05), LiNₓAl_{y}Co_{1-x-y}O₂ (where 0.95>x≥0.33; and y≥0.05), and LiNiₓMn_{y}Al_{Z}Co_{1-x-y-Z}O₂ (where 0.95>x≥0.33; y≥0.01; and Z≥0.01). S separators include a sulfide membrane, where A, C and S are integers greater than one.

### CROSS-REFERENCE TO RELATED APPLICATIONS

This application claims the benefit of Chinese Patent Application No. 202410141192.1 filed on Jan. 31, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to high-power all-solid-state battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

An all-solid-state battery cell includes A anode electrodes each including an anode active material layer arranged on an anode current collector. The anode current collector comprises a roughened outer surface, the anode active material layer comprises silicon, and the outer surface of the anode active material layer includes a plurality of convex spherical shapes. C cathode electrodes each including a cathode active material layer arranged on a cathode current collector. The cathode active material layer includes cathode active material and a sulfide solid electrolyte. The cathode active material is selected from a group consisting of LiNiₓMn_{y}Co_{1-x-y}O₂ (where 0.95>x≥0.33; and y≥0.05), LiNₓAl_{y}Co_{1-x-y}O₂ (where 0.95>x≥0.33; and y≥0.05), and LiNiₓMn_{y}Al_{Z}Co_{1-x-y-Z}O₂ (where 0.95>x≥0.33; y≥0.01; and Z≥0.01). S separators include a sulfide membrane, where A, C and S are integers greater than one.

In other features, the anode current collector is made of a material selected from a group consisting of copper, stainless steel, nickel, iron, titanium, tin, and alloys thereof. The anode current collector has a thickness in a range from 10 μm to 20 μm. The roughened outer surface has a roughness in a range from 0.1 μm to 12 μm.

In other features, a D50 particle size of the cathode active material is in a range from 2 μm to 10 μm. The cathode active material comprises an outer coating layer including lithium niobate (LiNbO₃). The outer coating layer comprises 0.5 wt % to 5 wt % of the cathode active material coated by the outer coating layer. The sulfide solid electrolyte comprises Li₆PS₅Cl.

In other features, the cathode active material layer comprises the cathode active material in a range from 40 wt % to 90 wt %, the sulfide solid electrolyte in a range from 10 wt % to 50 wt %, a conductive additive in a range from 0.1 wt % to 10 wt %, and a binder in a range from 0.1 wt % to 3 wt %. The maximum thickness of the anode active material layer is in a range from 5 μm to 20 μm.

In other features, a peak to trough distance of the plurality of convex spherical surfaces is in a range from 0.1 μm to 5 μm. The sulfide membrane comprises sulfide solid electrolyte and a binder. The sulfide solid electrolyte comprises Li₆PS₅Cl and the binder comprises poly(ethylene oxide) (PEO). The S separators comprise the sulfide solid electrolyte in a range from 85 to 99 wt %, the binder in a range from 1 wt % to 10 wt %, and a filler in a range from 0.1 wt % to 1 wt %.

In other features, the S separators comprise a lithium salt in a range from 0.1 wt % to 5 wt % of the sulfide membrane, and the lithium salt is selected from a group consisting of lithium bis(trifluoromethanesulfonyl)imide (LiTFSI), lithium bis (fluorosulfonyl)imide (LiFSI), lithium tetrafluoroborate (LiBF₄), lithium perchlorate (LiClO₄), and combinations thereof.

In other features, the filler is selected from a group consisting of an oxide-based sulfide solid electrolyte and a ceramic oxide.

An all-solid-state battery cell includes A anode electrodes each including an anode active material layer arranged on an anode current collector. The anode current collector comprises a roughened outer surface, the anode active material layer comprises silicon, and the outer surface of the anode active material layer includes a plurality of convex spherical shapes. C cathode electrodes each include a cathode active material layer arranged on a cathode current collector. The cathode active material layer includes cathode active material and a sulfide solid electrolyte comprising Li₆PS₅Cl. The cathode active material is selected from a group consisting of LiNiₓMn_{y}Co_{1-x-y}O₂ (where 0.95>x≥0.33; and y≥0.05), LiNₓAl_{y}Co_{1-x-y}O₂ (where 0.95>x≥0.33; and y≥0.05), and LiNiₓMn_{y}Al_{Z}Co_{1-x-y-Z}O₂ (where 0.95>x≥0.33; y≥0.01; and Z≥0.01). The cathode active material comprises an outer coating layer including lithium niobate (LiNbO₃). S separators comprising a sulfide membrane comprising Li₆PS₅Cl and a binder comprising poly(ethylene oxide) (PEO), where A, C and S are integers greater than one.

In other features, the anode current collector is made of a material selected from a group consisting of copper, stainless steel, nickel, iron, titanium, tin, and alloys thereof. The anode current collector has a thickness in a range from 10 μm to 20 μm. The roughened outer surface has a roughness in a range from 0.1 μm to 12 μm.

In other features, a peak to trough distance of the plurality of convex spherical surfaces is in a range from 0.1 μm to 5 μm. The S separators comprise the sulfide solid electrolyte in a range from 85 to 99 wt %, the binder in a range from 1 wt % to 10 wt %, and a filler in a range from 0.1 wt % to 1 wt %.

In other features, the S separators comprise a lithium salt in a range from 0.1 wt % to 5 wt % of the sulfide membrane. The filler is selected from a group consisting of an oxide-based sulfide solid electrolyte and a ceramic oxide.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of an all-solid-state battery cell including cathode electrodes, anode electrodes and separators according to the present disclosure;

FIG. 2A is a side cross section of an example of a cathode electrode according to the present disclosure;

FIG. 2B is a side cross section of an example of a particle of cathode active material with an outer coating layer according to the present disclosure;

FIG. 3 is a side cross section of an example of an anode electrode according to the present disclosure;

FIG. 4 is a side cross section of an example of an anode electrode, a cathode electrode, and a separator of an all-solid-state battery cell according to the present disclosure;

FIGS. 5 and 6 are graphs illustrating capacity as a function of cycles, and voltage as a function of capacity, respectively, for different discharge rates for an example of an all-solid-state battery according to the present disclosure;

FIG. 7 is a graph illustrating voltage as a function of capacity at different charge rates for an example of an all-solid-state battery according to the present disclosure;

FIG. 8 is a graph illustrating voltage as a function of capacity during 3C charge/3C discharge cycling for an example of an all-solid-state battery according to the present disclosure; and

FIG. 9 is a graph illustrating capacity and columbic efficiency as a function of cycles during 3C charge/3C discharge cycling for an example of an all-solid-state battery according to the present disclosure.

In the drawings, reference numbers may be reused to identify similar and/or identical elements.

### DETAILED DESCRIPTION

While battery cells according to the present disclosure are shown in the context of electric vehicles, the all-solid-state battery cells can be used in stationary applications and/or other applications.

All-solid-state battery cells provide increased safety and a wide working temperature range. However, reliably integrating electrode active material to enable high power capability while retaining long-term cycling is technically challenging. All-solid-state battery cells have less efficient micro-level lithium-ion conduction between the active material and the solid electrolyte particles and macro-level lithium-ion conduction between the electrode layer and the solid electrolyte layer.

An advanced all-solid-state battery according to the present disclosure with good power capability and good cell cyclability includes a dry-film cathode electrode, a separator including a high-ionic-conductivity, sulfide solid electrolyte membrane, and a silicon anode electrode. The silicon anode electrode includes a plurality of convex spherical-shaped surfaces created by depositing silicon onto a roughened anode current collector using physical vapor deposition (PVD).

The all-solid-state battery cell builds up favorable lithium-ion conduction at particle-to-particle interfaces and layer-to-layer interfaces. The convex spherical surfaces of the silicon anode electrode release stress generated during cycling and accommodate expansion of the lithiated silicon, which enhances cell cyclability. The all-solid-state battery cell provides a good discharge rate and good fast-charging capability. The all-solid-state battery cell enables stable battery cell cycling for more than 600 cycles.

In some examples, the cathode electrodes are manufactured using a dry roll-to-roll process. In some examples, a cathode active material layer includes cathode active material, a sulfide solid electrolyte, and a fibrillating binder (e.g., polytetrafluoroethylene (PTFE)). The dry manufacturing process eliminates the use of solvents and their influence on lithium-ion conduction of the sulfide solid electrolyte. The dry process also eliminates the need for drying equipment to remove the solvent from the cathode active material layer after casting.

In some examples, the separators include a membrane comprising sulfide solid electrolyte and a binder (e.g., poly(ethylene oxide) (PEO)). In some examples, the separators are manufactured using a wet process to enable thin thicknesses. The separators can be cast onto the cathode electrode or the anode electrode, or manufactured as a free-standing membrane on a removable substrate. In some examples, the PEO binder is preprocessed using LiTFSI and Si₂O particles to decrease crystallinity of the polymer binder and enhance ion conductivity.

In some examples, the anode electrodes include silicon active material including a plurality of convex spherical surfaces deposited on a roughened anode current collector. The plurality of convex spherical surfaces enables more surface area to interact with the sulfide solid electrolyte of the separator membrane to increase lithium-ion conduction paths and enhance the power capability of the all-solid-state battery cell. The plurality of convex spherical surfaces also helps to release stress during cycling by accommodating expansion of the lithiated silicon.

Referring now to FIG. 1, an all-solid-state battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. The C cathode electrodes 20-1, 20-2, . . . , and 20-C include cathode active material layers 24 arranged on one or both sides of a cathode current collector 26.

The A anode electrodes 40-1, 40-2, . . . , and 40-A include anode active material layers 42 arranged on one or both sides of the anode current collectors 46. During charging/discharging, the A anode electrodes 40 and the C cathode electrodes 20 exchange lithium ions. In some examples, the cathode active material layers 24 are manufactured using a dry process. A mixture including one or more cathode active materials, sulfide solid electrolyte, and/or one or more binders is mixed/sheared to create fibrils, transferred onto the cathode current collectors, and calendared.

In some examples, the cathode current collector 26 and/or the anode current collector 46 comprise metal foil, metal mesh, perforated metal, 3 dimensional (3D) metal foam, and/or expanded metal. External tabs 28 and 48 are connected to the current collectors of the cathode electrodes and anode electrodes, respectively, and can be arranged on the same or different sides of the battery cell stack 12. The external tabs 28 and 48 are connected to terminals of the all-solid-state battery cells.

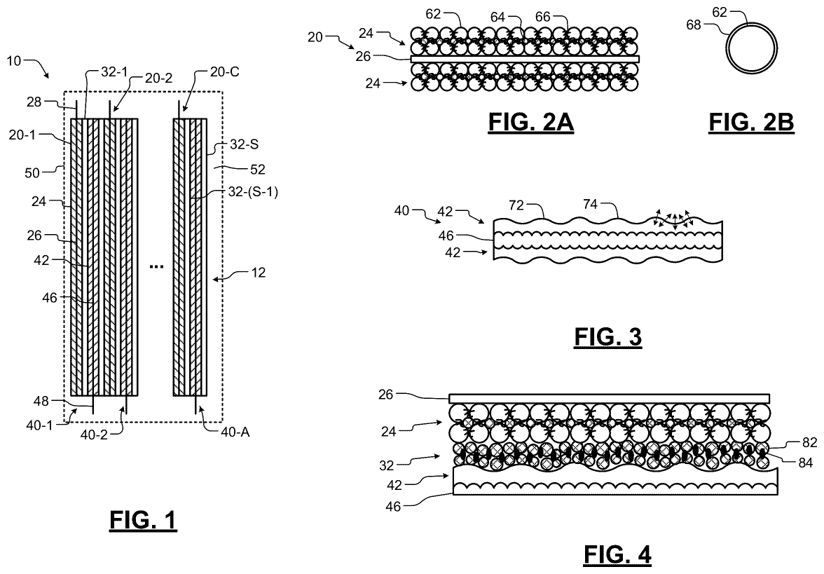

Referring now to FIGS. 2A and 2B, one of the C cathode electrodes 20 is shown in further detail. In FIG. 2A, the cathode active material layer 24 of the C cathode electrodes 20 includes cathode active material 62, sulfide solid electrolyte 64, and a fibrillating binder 66 that are mixed/sheared to create fibrils and transfer onto the cathode current collector using a dry roll-to-roll process.

In some examples, the cathode active material comprises LiNiₓMn_{y}Co_{1-x-y}O₂ (where 0.95>x≥0.33; and y≥0.05). In some examples, a D50 particle size of the cathode active material is in a range from 2 μm to 10 μm. In some examples, capacity of the cathode active material is in a range from 140 to 200 mAh/g (1C). In some examples, Brunauer, Emmett and Teller (BET) of the cathode active material is in a range from 0.1 to 1.0 m²/g.

In some examples, the cathode active material comprises LiNₓAl_{y}Co_{1-x-y}O₂ (where 0.95>x≥0.0.33; and y≥0.05). In some examples, a D50 particle size of the cathode active material is in a range from 2 μm to 10 μm. In some examples, capacity of the cathode active material is in a range from 140 to 200 mAh/g (1C). In some examples, Brunauer, Emmett and Teller (BET) of the cathode active material is in a range from 0.1 to 1.0 m²/g.

In some examples, the cathode active material comprises LiNiₓMn_{y}Al_{Z}Co_{1-x-y-Z}O₂ (where 0.95>x≥0.33; y≥0.01; and Z≥0.01). In some examples, a D50 particle size of the cathode active material is in a range from 2 μm to 10 μm. In some examples, the capacity of the cathode active material is in a range from 140 to 180 mAh/g (1C). In some examples, Brunauer, Emmett and Teller (BET) of the cathode active material is in a range from 0.1 to 1.0 m²/g.

In some examples, the cathode active material includes an outer coating layer 68 (FIG. 2B). In some examples, the outer coating layer 68 comprises lithium niobate (LiNbO₃). In some examples, the outer coating layer 68 comprises 0.5 wt % to 5 wt % of the coated cathode active material.

In some examples, the cathode active material layer comprises the cathode active material in a range from 40 wt % to 90 wt %, the sulfide solid electrolyte in a range from 10 wt % to 50 wt %, an optional conductive additive (e.g., carbon black) in a range from 0 wt % to 10 wt % (e.g. 0.1 wt % to 10 wt %), and a binder (e.g., polytetrafluoroethylene (PTFE)) in a range from 0.1 wt % to 3 wt %. In some examples, the cathode current collector comprises aluminum foil having a thickness in a range from 8 μm to 20 μm and a density in a range from 3.6 to 3.8 g/cm³. In some examples, capacity loading is in a range from 1 to 6 mAh/cm² (for a single side coating at 1C and room temperature).

Referring now to FIG. 3, one of the A anode electrodes 40 is shown in further detail. The anode active material layer 42 includes silicon active material 72 including a plurality of convex spherical surfaces 74. For example, silicon anodes with the plurality of convex spherical surfaces are described in commonly-assigned U.S. patent application Ser. Nos. 18/633,792 and 18/639,208 (GM Docket Nos. P104391 and P106770), which are hereby incorporated herein by reference.

In some examples, the anode current collector 46 has a thickness in a range from 10 μm to 20 μm. In some examples, the roughened surface of the anode current collector 46 has a roughness (Rₐ) in a range from 0.1 μm to 12 μm. In some examples, the anode current collector 46 is made of a material selected from a group consisting of copper, stainless steel, nickel, iron, titanium, tin, and alloys thereof.

In some examples, the anode active material is deposited onto the anode current collector 46 using physical vapor deposition (PVD). As a result, the anode electrode is manufactured without using a binder or a conductive additive. In some examples, an outer surface of the silicon active material 72 includes the plurality of convex spherical surfaces 74 to increase interface surface area with the sulfide solid electrolyte of the S separators 32, which increases lithium ion conduction paths and enhances the power capability of the all-solid-state battery cell. The plurality of convex spherical surfaces 74 also release the generated stress during cycling (e.g., by accommodating expansion and contraction (as shown by arrows)) and enhance the cyclability of the all-solid-state battery cell. Removing the binder, which acts as an ionic insulator, enhances power capability. Removing the carbon additive eliminates adverse reactions, which prolongs the cycle life of the all-solid-state battery cell.

In some examples, a maximum thickness (at a peak of the plurality of convex spherical surfaces 74 to a trough of the roughened anode current collector 46) is in a range from 5 μm to 20 μm. In some examples, a peak to trough of the plurality of convex spherical surfaces 74 is in a range from 0.1 μm to 5 μm. In some examples, the A anode electrodes 40 have a total thickness in a range from 15 μm to 40 μm and areal loading in a range from 3 to 10 mAh/cm².

Referring now to FIG. 4, the S separators 32 comprise a membrane including sulfide solid electrolyte 82, a binder 84, an optional lithium salt, and a filler. In some examples, the sulfide solid electrolyte comprises lithium-argyrodite (Li₆PS₅Cl or, in short as LPSCl). In some examples, the S separators 32 comprise the sulfide solid electrolyte in a range from 85 to 99 wt %, the binder in a range from 1 to 10 wt %, the optional lithium salt in a range from 0 wt % to 5 wt % (e.g., 0.1 wt % to 5 wt %), and a filler in a range from 0.1 wt % to 1 wt %. In some examples, the binder 84 comprises poly(ethylene oxide) (PEO) having an average molecular weight (Mv) in a range from 100,000 to 600,000 (nominal) and a transition temperature in a range from 60 to 70° C.

In some examples, the filler comprises an oxide-based sulfide solid electrolyte (e.g., garnet type, Perovskite type, NASICON type, and/or LISICON type) or a ceramic oxide (Al₂O₃, SiO₂, TiO₂, and/or ZrO₂) and has a particle size diameter in a range from 2 nm to 200 nm. In some examples, the lithium salt is selected from a group consisting of lithium bis(trifluoromethanesulfonyl)imide (LiTFSI), lithium bis (fluorosulfonyl)imide (LiFSI), lithium tetrafluoroborate (LiBF₄), lithium perchlorate (LiClO₄), etc. In some examples, the S separators 32 have a thickness in a range from 20 to 80 μm and an ionic conductivity in a range from 0.1 to 2 mS/cm at 30° C. In some examples, an N/P ratio (capacity ratio between anode and cathode) is in a range from 1.5 to 2.8.

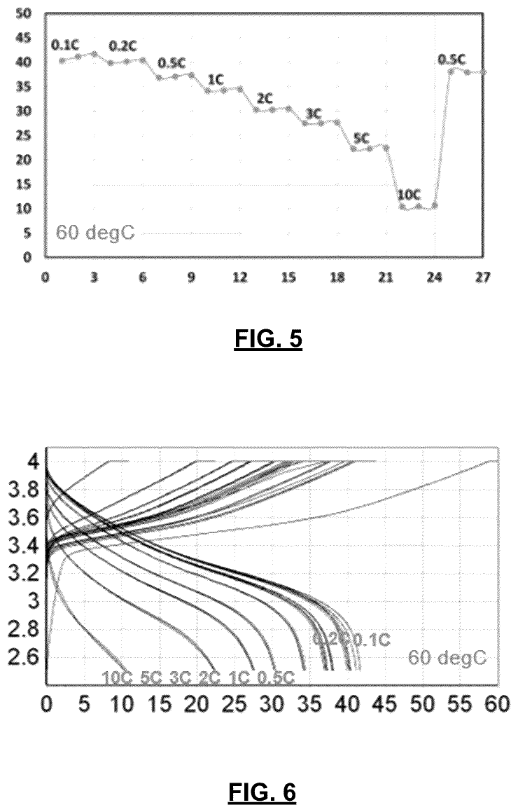

Referring now to FIGS. 5 and 6, discharge performance of an example of the all-solid-state battery cell is shown. The cathode active material layer comprises NMC532/Li₆PS₅Cl/carbon black/PTFE binder at a ratio of 56/40/4/1 wt % and a loading of 1.5 mAh/cm². The S separators 32 comprise a sulfide membrane comprising LiPS₅Cl/PEO/LiTFSI/SiO₂ at a ratio of 95/5/0.5/0.2 wt % and a loading of 3.7 mAh/cm². As can be appreciated, the all-solid-state battery cell has good discharge rate capability, even at 10C.

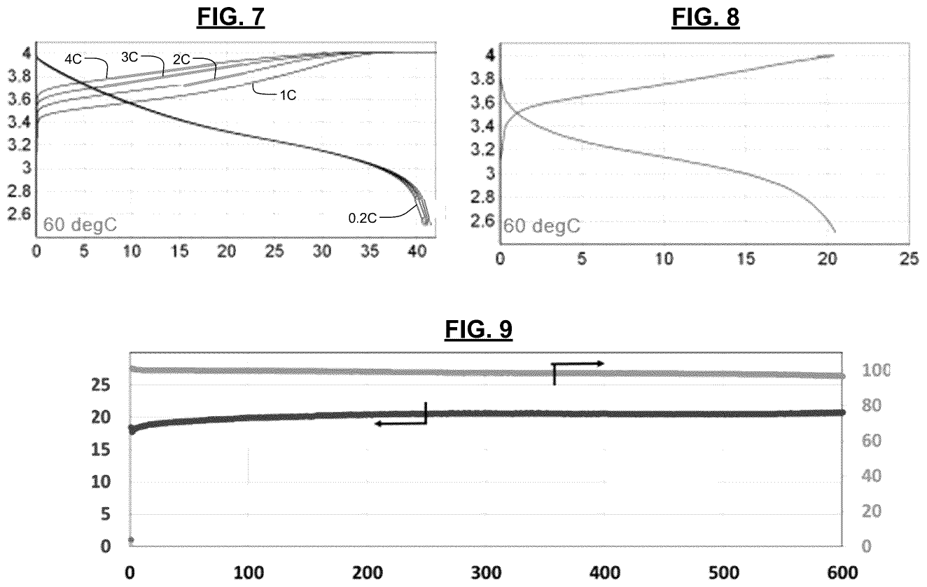

Referring now to FIGS. 7 to 9, charging and charging/discharging performance of the example of the all-solid-state battery cell of FIGS. 5 and 6 is shown. As can be seen in FIGS. 7 and 8, the all-solid-state battery cell demonstrates good fast-charging capability. In FIG. 9, the all-solid-state battery cell demonstrates excellent cell cyclability after 600 cycles.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. An all-solid-state battery cell comprising:
A anode electrodes each including an anode active material layer arranged on an anode current collector,
wherein the anode current collector comprises a roughened outer surface, the anode active material layer comprises silicon, and an outer surface of the anode active material layer includes a plurality of convex spherical shapes;
C cathode electrodes each including a cathode active material layer arranged on a cathode current collector,
wherein the cathode active material layer includes cathode active material and a sulfide solid electrolyte,
wherein the cathode active material is selected from a group consisting of LiNiₓMn_{y}Co_{1-x-y}O₂ (where 0.95>x≥0.33; and y≥0.05), LiNₓAl_{y}Co_{1-x-y}O₂ (where 0.95>x≥0.33; and y≥0.05), and LiNiₓMn_{y}Al_{Z}Co_{1-x-y-Z}O₂ (where 0.95>x≥0.33; y≥0.01; and Z≥0.01); and
S separators comprising a sulfide membrane, where A, C and S are integers greater than one.

2. The all-solid-state battery cell of claim 1, wherein the anode current collector is made of a material selected from a group consisting of copper, stainless steel, nickel, iron, titanium, tin, and alloys thereof.

3. The all-solid-state battery cell of claim 1, wherein
the anode current collector has a thickness in a range from 10 μm to 20 μm, and
the roughened outer surface has a roughness in a range from 0.1 μm to 12 μm.

4. The all-solid-state battery cell of claim 1, wherein a D50 particle size of the cathode active material is in a range from 2 μm to 10 μm.

5. The all-solid-state battery cell of claim 1, wherein the cathode active material comprises an outer coating layer including lithium niobate (LiNbO₃).

6. The all-solid-state battery cell of claim 5, wherein the outer coating layer comprises 0.5 wt % to 5 wt % of the cathode active material coated by the outer coating layer.

7. The all-solid-state battery cell of claim 1, wherein the sulfide solid electrolyte comprises Li₆PS₅Cl.

8. The all-solid-state battery cell of claim 1, wherein the cathode active material layer comprises:
the cathode active material in a range from 40 wt % to 90 wt %,
the sulfide solid electrolyte in a range from 10 wt % to 50 wt %,
a conductive additive in a range from 0.1 wt % to 10 wt %, and
a binder in a range from 0.1 wt % to 3 wt %.

9. The all-solid-state battery cell of claim 1, wherein a maximum thickness of the anode active material layer is in a range from 5 μm to 20 μm.

10. The all-solid-state battery cell of claim 1, wherein a peak to trough distance of the plurality of convex spherical surfaces is in a range from 0.1 μm to 5 μm.

11. The all-solid-state battery cell of claim 1, wherein the sulfide membrane comprises sulfide solid electrolyte and a binder.

12. The all-solid-state battery cell of claim 11, wherein the sulfide solid electrolyte comprises Li₆PS₅Cl and the binder comprises poly(ethylene oxide) (PEO).

13. The all-solid-state battery cell of claim 11, wherein the S separators comprise the sulfide solid electrolyte in a range from 85 to 99 wt %, the binder in a range from 1 wt % to 10 wt %, and a filler in a range from 0.1 wt % to 1 wt %.

14. The all-solid-state battery cell of claim 13, wherein:
the S separators comprise a lithium salt in a range from 0.1 wt % to 5 wt % of the sulfide membrane, and
the lithium salt is selected from a group consisting of lithium bis (trifluoromethanesulfonyl)imide (LiTFSI), lithium bis(fluorosulfonyl)imide (LiFSI), lithium tetrafluoroborate (LiBF₄), lithium perchlorate (LiClO₄), and combinations thereof.

15. The all-solid-state battery cell of claim 13, wherein the filler is selected from a group consisting of an oxide-based sulfide solid electrolyte and a ceramic oxide.

16. An all-solid-state battery cell comprising:
A anode electrodes each including an anode active material layer arranged on an anode current collector,
wherein the anode current collector comprises a roughened outer surface, the anode active material layer comprises silicon, and an outer surface of the anode active material layer includes a plurality of convex spherical shapes;
C cathode electrodes each including a cathode active material layer arranged on a cathode current collector,
wherein the cathode active material layer includes cathode active material and a sulfide solid electrolyte comprising Li₆PS₅Cl,
wherein the cathode active material is selected from a group consisting of LiNiₓMn_{y}Co_{1-x-y}O₂ (where 0.95>x≥0.33; and y≥0.05), LiNₓAl_{y}Co_{1-x-y}O₂ (where 0.95>x≥0.33; and y≥0.05), and LiNiₓMn_{y}Al_{Z}Co_{1-x-y-Z}O₂ (where 0.95>x≥0.33; y≥0.01; and Z≥0.01), and
wherein the cathode active material comprises an outer coating layer including lithium niobate (LiNbO₃); and
S separators comprising a sulfide membrane comprising Li₆PS₅Cl and a binder comprising poly(ethylene oxide) (PEO), where A, C and S are integers greater than one.

17. The all-solid-state battery cell of claim 16, wherein:
the anode current collector is made of a material selected from a group consisting of copper, stainless steel, nickel, iron, titanium, tin, and alloys thereof,
the anode current collector has a thickness in a range from 10 μm to 20 μm, and
the roughened outer surface has a roughness in a range from 0.1 μm to 12 μm.

18. The all-solid-state battery cell of claim 16, wherein a peak to trough distance of the plurality of convex spherical surfaces is in a range from 0.1 μm to 5 μm.

19. The all-solid-state battery cell of claim 16, wherein the S separators comprise the sulfide solid electrolyte in a range from 85 to 99 wt %, the binder in a range from 1 wt % to 10 wt %, and a filler in a range from 0.1 wt % to 1 wt %.

20. The all-solid-state battery cell of claim 19, wherein:
the S separators comprise a lithium salt in a range from 0.1 wt % to 5 wt % of the sulfide membrane, and
the filler is selected from a group consisting of an oxide-based sulfide solid electrolyte and a ceramic oxide.
